(19) United States
(12) Patent Application Publication
(10) Pub. No.: US 2018/0109215 A1
(43) Pub. Date: Apr. 19, 2018

(54) THERMAL FUSE PROTECTION OF A FORM COIL GENERATOR OF A WIND POWER PLANT

(71) Applicant: Wobben Properties GmbH, Aurich (DE)

(72) Inventor: Jochen RÖER, Ganderkesee (DE)

(21) Appl. No.: 15/846,003

(22) Filed: Dec. 18, 2017

Related U.S. Application Data
(63) Continuation-in-part of application No. PCT/EP2016/064176, filed on Jun. 20, 2016.

(30) Foreign Application Priority Data
Jun. 19, 2015 (DE) 10 2015 211 390.6

(51) Int. Cl. H02P 9/00; H02H 3/04

(52) U.S. Cl. CPC H02P 9/006; H02H 3/046

(57) ABSTRACT

A generator of a gearless wind power installation, with a rotor and a stator, wherein at least the rotor or the stator is provided with a fuse wire, for detecting a local temperature increase, and wherein the fuse wire comprises an electrically conducting material and the electrically conducting material melts when a predetermined temperature is reached, and thereby brings about an interruption of the electrical conduction, in order thereby to detect the local temperature increase.

### BACKGROUND

### Technical Field

The present invention relates to a generator of a gearless wind power installation and to a fuse wire for such a generator. Furthermore, the present invention relates to a method for monitoring coil contact points in a generator. The present invention also relates to a wind power installation.

### Description of the Related Art

Wind power installations are known and modern wind power installations are often gearless, so that they have a slowly running multi-pole generator. Here there may be for example 96 or 192 poles or even more poles. If each pole is provided with a coil, which has to be brought into electrical contact with at least one further coil to connect them together, a corresponding number of contact points are created. Such a contact point is in principle always a source of a potential fault. If there are few contact points, faults can be all but eliminated by precise final inspection and possibly later checking. If there are many contact points, however, the risk of a potential fault increases.

For this reason, it was proposed in the patent U.S. Pat. No. 7,432,610 to wind the stator of such a ring generator continuously. Therefore, no contact points are provided there, or at least only for connecting the six phases to a downstream rectifier.

However, such continuous winding is laborious and, because of the necessary use of copper, also quite expensive. For this reason, it may be proposed to use form-wound coils, which can also be produced from aluminum, in the stator instead of such a continuous stator winding. However, for a multi-pole ring generator, this creates a large number of contact points, which correspondingly have the problem that they may be faulty. That may sometimes not occur until operation, or only be noticed during operation. Such a faulty contact point particularly entails the risk of a high contact resistance occurring there, and consequently of the current in the corresponding stator winding causing considerable heating at this high-resistance contact point. In the worst case, that may lead to a generator fire.

The German Patent and Trademark Office has searched the following prior art in the priority application relating to the present application: DE 10 2006 016 135 A1, DE 10 2008 031 582 A1, DE 10 2013 109 518 A1, DE 10 2013 109 518 A1, JP 2001-263238 A.

### BRIEF SUMMARY

Provided is a system and method intended to detect or avoid a dangerous temperature increase that can occur at contact points of form-wound coils of a stator of a generator of a gearless wind power installation. At least it is intended to propose an alternative solution to the solutions known so far.

Provided is a generator of a gearless wind power installation has a rotor and a stator and in this respect it is proposed that the stator is provided with a fuse wire, for detecting a local temperature increase, and the fuse wire comprises an electrically conducting material and the electrically conducting material melts when a predetermined temperature is reached, and thereby brings about an interruption of the electrical conduction, in order thereby to detect the local temperature increase.

Consequently, a fuse wire that is intended to detect a local temperature increase is provided for the stator. For this purpose, the fuse wire comprises an electrically conducting material that melts when a predetermined temperature is reached, that is its melting temperature. As a result, if this high temperature or of course a higher temperature occurs, this conducting material will melt at the point or in the region in which this high temperature occurs. This results in an interruption of the electrical conduction and this electrical interruption can be detected. This may take place for example by regularly measuring the electrical resistance of this fuse wire. For this purpose, a small test current may also flow through this fuse wire, the current and voltage being monitored, to mention just one variant.

An inadmissibly high temperature is consequently detected by an electrical interruption in the fuse wire. Such monitoring can consequently be carried out comparatively easily. It does not require any ground potential, but just this monitoring of the electrical conductivity. Furthermore, in this way many points of potential overheating can be monitored by a single fuse wire.

Preferably, the fuse wire is laid once around the stator. This may in particular take place around the stator in an approximately circular manner. This therefore proposes a comprehensive protective measure that can be achieved by this one fuse wire for the entire stator, and only additionally requires an evaluation unit.

The proposed solution with the fuse wire is also comparatively failsafe, because the solution is based on monitoring by a portion of the fuse wire melting, that is melting away. This variant may particularly also be advantageous in comparison with one in which there are arranged alongside one another in an insulated manner a number of electrically conductive lines or wires which do not melt at critical temperatures, but of which an insulation between the wires or from a wire to a ground potential is thermally sensitive. In the case of such monitoring based on the changing of an insulation, there is the risk that the insulation is destroyed or damaged by the temperature increase to be monitored without however resulting in a contact between the electrical lines that should occur in the event of destruction of the insulation. In this case, there would even be additionally the risk that such a thermally damaged insulation could itself cause a fire.

In any event, provided is the melting of the electrically conducting material as such.

It is also proposed to use the fuse wire analogously for the rotor and to sense temperature increases there. This may take place as an alternative or in addition to the monitoring of the stator.

According to one embodiment, it is proposed that the stator is made up of form-wound coils. This should be understood as meaning that the stator windings of the stator are made up of form-wound coils. These form-wound coils are connected to one another at coil contact points. For this, it is proposed that the fuse wire is laid along the contact points of the stator, in order to detect whether a temperature increase occurs at a coil contact point. Preferably, the generator, and consequently the stator, is made up in such a way that the coil contact points are uniformly arranged substantially in an annular region. The fuse wire then only needs to be laid around the stator once along this ring, that is to say in a circular manner. Consequently, the fuse wire can monitor a temperature increase at each of these contact points, of which there may be over 100 on a stator, in an easy way.

It is pointed out that the invention nevertheless assumes that such a detection of a temperature increase never occurs. It is therefore an extremely precautionary measure. Should there nevertheless be such an instance of a local temperature increase occurring, and the fuse wire allowing this to be detected, it is initially not important where exactly this temperature increase has occurred. In other words, it is initially not important which of the many contact points is defective. First the wind power installation can be run down and the generator electrically disconnected, in order to eliminate the possibility of a serious breakdown.

Once the installation has been run down and the generator electrically disconnected, a search for the fault can be carried out. The fuse wire may then also help in the search for the fault. Either a deformation that indicates the location of the temperature increase is already evident from the fuse wire, or such a location can be narrowed down quite quickly by a number of conductivity measurements.

According to a further embodiment, it is proposed that the fuse wire is made up in such a way that the electrically conducting material is accommodated in a sheathing in such a way that, in the event of melting, it can run away in the sheathing in such a way that an interruption of the electrical conductivity of the fuse wire is achieved. This can be achieved particularly easily by the sheathing that is provided for the electrical insulation of the fuse wire not being completely filled by the electrically conducting material, that is to say the actual wire.

This sheathing may therefore be formed as a tube with an average inside diameter that is greater than the outside diameter of the electrically conducting material therein, that is to say greater than the outside diameter of a wire that substantially forms the electrically conducting material. Preferably, this sheathing also has an inherent stiffness, which prevents this sheathing from collapsing without corresponding filling. This allows this sheathing to surround the electrically conducting material, that is to say the electrically conducting wire, in a way similar to a pipe, without fitting tightly around it. An accurate circular or very constant inside diameter or otherwise accurate cross-sectional forms of the sheathing are not important here, but rather only that its inherent stiffness allows a certain free space for the running away of molten material of the electrically conducting material. Preferably, however, a pipe is used as the sheathing.

According to one embodiment, the temperature resistance of the sheathing is higher than the melting point of the electrically conducting material. This allows the effect to be achieved that, in spite of a temperature increase to such a high degree that the electrically conductive material melts, it does not leave the sheathing. As a result, further damage can particularly be avoided. This concerns both immediate damage, such as short-circuits, which could lead to an additional problem, and later contamination, which would have to be additionally removed after repairing the damaged point. The temperature resistance of this sheathing is therefore such that the sheathing is still intact even when the electrically conducting material has melted. Preferably, the sheathing withstands a temperature that lies at least 20° C., preferably at least 50° C., above the melting temperature of the electrically conducting material.

The predetermined temperature of the electrically conducting material, that is to say the melting temperature of the electrically conducting material, is favorably in the range of 160° C. to 200° C., preferably in the range of 170° C. to 190° C., and it is proposed in particular to make it approximately 180° C.

These temperatures are chosen such that they are sufficiently high to allow the fuse wire only to respond whenever there is a dangerous temperature increase. Nevertheless, they are chosen to be low enough that the fuse wire also does not respond too late. To this extent, the proposed temperature values still lie below temperatures at which a fire would immediately occur.

Preferably, the generator is formed as a ring generator. Accordingly, the magnetically active regions of the rotor and stator, that is particularly the laminated cores of the stator and the rotor, are arranged in an annular region around the air gap that separates the rotor and the stator. In this case, the generator is free from magnetically active regions in an inner region with a radius of at least 50% of the average air gap radius.

A ring generator may also be defined in that the radial thickness of the magnetically active parts, or to put it another way of the magnetically active region, that is the radial thickness from the inner periphery of the magnet wheel to the outer periphery of the stator, or from the inner periphery of the stator to the outer periphery of the rotor in the case of an external rotor, is less than the air gap radius, in particular in that the radial thickness of the magnetically active region of the generator is less than 30%, in particular less than 25%, of the air gap radius. Furthermore or alternatively, a ring generator may be defined in that the depth, that is the axial extent, of the generator is less than the air gap radius, in particular in that the depth is less than 30%, in particular less than 25%, of the air gap radius. Furthermore or alternatively, a ring generator is formed with multiple poles and so has at least 48, 96, in particular at least 192 rotor poles.

The solution of temperature monitoring by means of the fuse wire is proposed particularly for such a ring generator. Particularly such ring generators comprise a very large number of poles, have a large overall size and are moreover slow running. In the case of these generators, a particularly large region has to be monitored, which can be achieved by the proposed fuse wire in an easy way.

A generator of a gearless wind power installation with a rotor and a stator is proposed, wherein
at least the rotor or the stator is provided with an optical waveguide (LWL), for detecting a local temperature increase, and
the optical waveguide (LWL)
is prepared for transmitting light waves and the transmission of light waves is monitored by way of a lightwave evaluation unit and
the transmission of the light waves through the optical waveguide changes when a predetermined temperature is reached or exceeded and this change, in particular an interruption of the transmission, can be detected by the lightwave evaluation unit.

Excessive heating, even only local excessive heating, of the optical waveguide changes the transmission behavior, and this is sensed by the lightwave evaluation unit. Particularly an interruption can be detected. However, also a change in the quality of the light signal can be detected, in particular a frequency shift or other frequency change. The use of an optical waveguide thus allows the generator to be monitored over its entire circumference by just one optical waveguide. The type and location and the use of the optical waveguide and any further features involved in the use may correspond, possibly by analogy, to those that have been explained or are still to be explained in connection with the fuse wire. The use of an optical waveguide is particularly advantageous for the monitoring of many potential sources of a fault on a ring generator by just one optical waveguide, and consequently by just one monitoring means.

Also proposed according to the invention is a fuse wire. Such a fuse wire is provided for detecting a local temperature increase at a generator of a gearless wind power installation and it comprises an electrically conducting material that melts when a predetermined temperature, that is a predetermined melting temperature, is reached and, as a result, brings about an interruption of the electrical line, in order thereby to detect the local temperature increase.

Explanations of the fuse wire follow from explanations of embodiments for the generator proposed.

In particular, such a fuse wire is prepared for use in a generator according to at least one embodiment described above. This preparation concerns here in particular the dimensioning, that is to say that it has a sufficient length and, with regard to its diameter, can be led particularly along the stator, and there preferably along any contact points of form-wound coils.

Also proposed is a method for thermally monitoring coil contact points in a generator of a gearless wind power installation. This is proposed particularly for monitoring the stator, and in particular for a stator with form-wound coils. Here, a fuse wire is led along such coil contacts, or other problem points, and the conductivity of the fuse wire is measured while the wind power installation is in ongoing operation. If the conductivity of the fuse wire deteriorates significantly, a warning signal is generated. This preferably takes place whenever the fuse wire is interrupted in its electrical conductivity. Consequently, a temperature increase can be reliably detected particularly in ongoing operation.

If such a problem is detected, if therefore a warning signal is generated, it is proposed according to one embodiment to run down the wind power installation and electrically disconnect the generator, in particular disconnect it from a downstream rectifier, and in particular disconnect it from a power supply for an excitation current. As a result, the possibility of consequential damage can be eliminated and the wind power installation is then brought into a state that is safe and allows a diagnosis.

Preferably, the warning signal is given to a remote monitoring center. From such a remote monitoring center, further measures can then be initiated as quickly as possible and coordinated.

Also proposed is a wind power installation, which has a generator according to at least one of the embodiments described above. Furthermore or alternatively, the wind power installation is characterized in that it carries out a method according to at least one of the embodiments described for this above. Furthermore or alternatively, it is proposed that a fuse wire according to at least one embodiment described above in relation to the fuse wire is used in the wind power installation.

### BRIEF DESCRIPTION OF THE SEVERAL VIEWS OF THE DRAWINGS

The invention is explained in more detail below by way of example on the basis of embodiments with reference to accompanying figures.

FIG. 1 shows a wind energy installation schematically in a perspective view.

FIG. 2 schematically shows a ring generator of a gearless wind power installation.

FIG. 3 shows a detail of a contact region of form-wound coils of a stator of a gearless wind energy installation in a perspective view.

FIG. 4 shows a block diagram for a system for monitoring.

### DETAILED DESCRIPTION

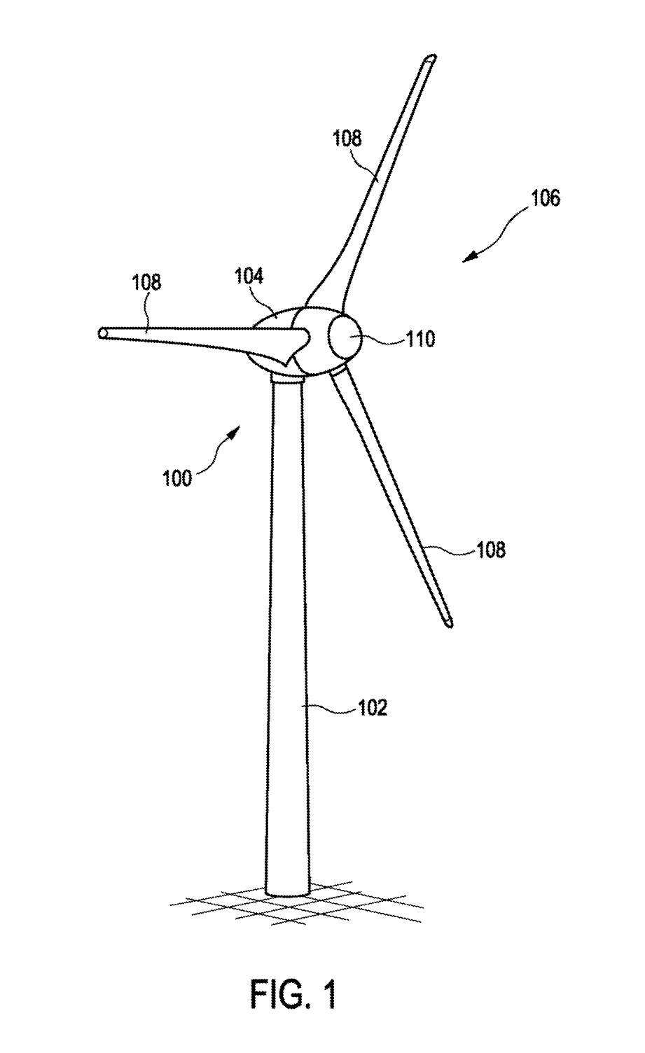

FIG. 1 shows a wind power installation 100 with a tower 102 and a nacelle 104. Arranged on the nacelle 104 is a rotor 106 with three rotor blades 108 and a spinner 110. During operation, the rotor 106 is set in a rotating movement by the wind and thereby drives a generator in the nacelle 104.

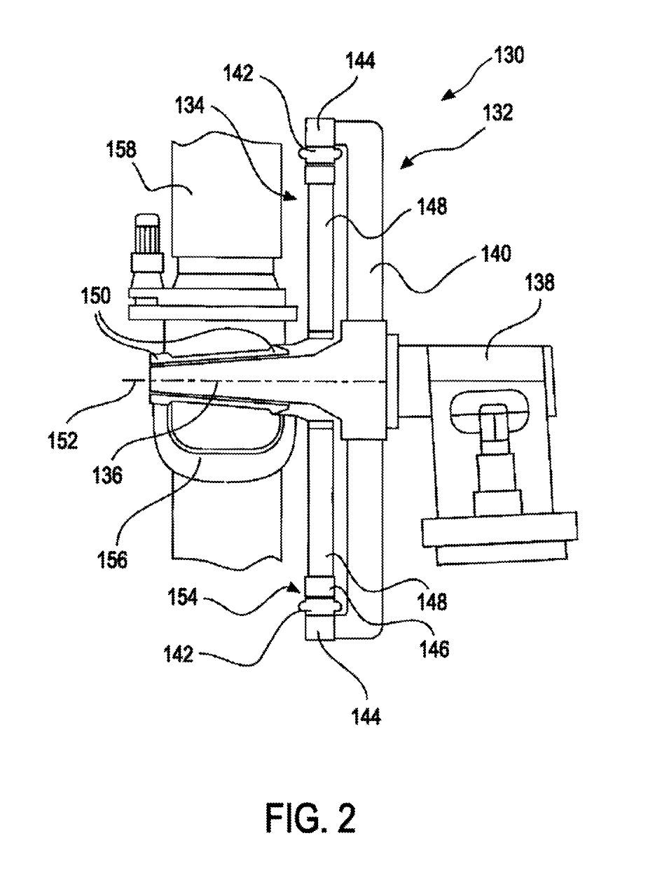

FIG. 2 shows a generator 130 schematically in a side view. It has a stator 132 and an electrodynamic rotor 134, which is mounted so as to be rotatable in relation thereto, and is secured with its stator 132 on a bed plate 138 by way of a journal 136. The stator 132 has a stator support 140 and laminated stator cores 142, which form stator poles of the generator 130 and are secured on the stator support 140 by way of a stator ring 144. The electrodynamic rotor 134 has rotor pole shoes 146, which form the rotor poles and are mounted on the journal 136 by way of a rotor support 148 and bearings 150 so as to be rotatable about the axis of rotation 152. The laminated stator cores 142 and rotor pole shoes 146 are separated only by a narrow air gap 154, which is a few mm wide, in particular less than 6 mm, but has a diameter of several meters, in particular more than 4 m. The laminated stator cores 142 and the rotor pole shoes 146 each form a ring and together are also annular, and therefore the generator 130 is a ring generator. In accordance with its purpose, the electrodynamic rotor 134 of the generator 130 rotates together with the rotor hub 156 of the aerodynamic rotor, of which the initial sections of rotor blades 158 are indicated.

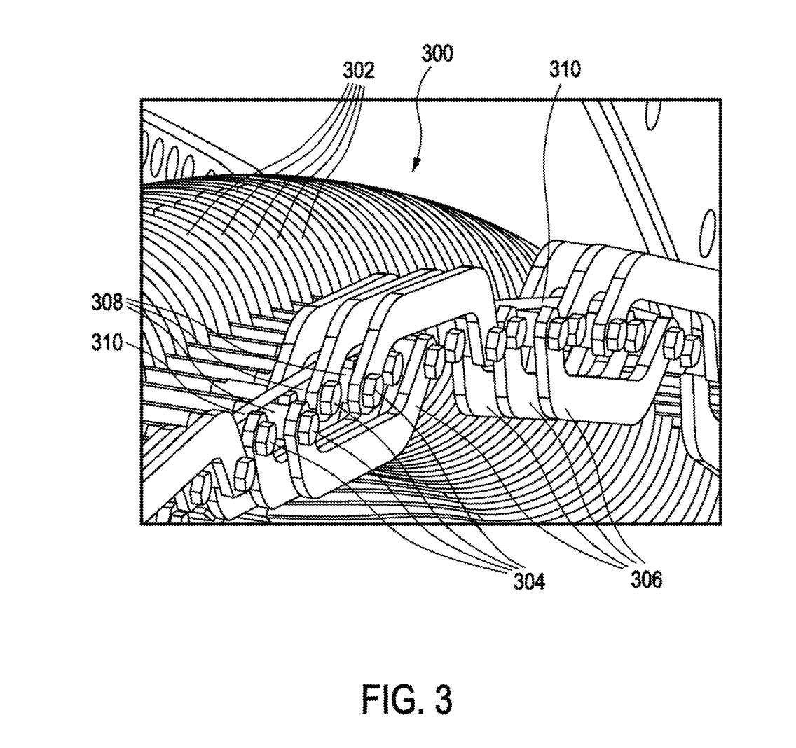

FIG. 3 shows in a perspective view a detail of a generator 300 with various form-wound coils 302, which are connected to one another at various contact points 304. In this case, two adjacent form-wound coils 302 of the same phase are always connected to one another. These form-wound coils 302 may differ from one another in details, the same reference numeral 302 always being used for the sake of better overall clarity. FIG. 3 shows here a detail from a generator 300, which is formed with six phases, in the case of which therefore the stator to which the form-wound coils 302 belong has six phases.

The contact points 304 also have in this case contact bridges 306, in order to bridge the geometrical distance between form-wound coils. Consequently, at the contact points 304, contact bridges 306 are secured to form-wound coil ends 308, that is in the example are screwed on. The reference numerals 304 for identifying the contact points indicate corresponding screw heads, but the contact points 304 are not restricted to these, but rather also include these form-wound coil ends 308. In any event, any temperature increase in the region of a contact point will also spread to such end portions 308.

Provided for the temperature monitoring is therefore a fuse wire 310, which here runs around the generator 300 essentially in a circular or annular manner. It is thereby laid in the region of the contact points 304 and lies partially between the contact bridges 306 and on form-wound coil ends 308, which to this extent can still be counted as belonging to the contact points 304. It is consequently evident that the fuse wire 310 can be laid in an easy way, and at the same time is in this case arranged in the vicinity of all the contact points 304.

The fuse wire 310 has in this case a sheathing, which in the embodiment shown essentially forms a torus. Inside it there is a low-melting wire.

Provided is a proposal for monitoring temperature increases at form-wound coils of a ring generator of a gearless wind power installation. Such a ring generator with form-wound coils may also be referred to as a form-wound coil generator.

In connection with a form-wound coil generator, it is inherent in the system that many contact points are required in the stator winding. The reliability of the generator depends on the reliability of all the contacts that are made. Since inadequate contacting can lead to the generator being damaged, it is advisable to detect a deteriorating contact in good time. Provided is a monitoring system that is capable of switching off the generator in good time.

The invention consequently concerns, in principle and in graphic terms, a fuse of a great size, which however is not heated up by its own current but by heating its vicinity. Consequently, not current but heating is monitored. In a casing tube or casing pipe that conducts heat as well as possible there is a conductor that has a defined melting temperature. This system is wound or laid around all of the contacting points in a preferably circular manner. If one of the contact points heats up to an inadmissible degree, the electrical conductor, which may also be referred to as a core wire, melts and causes an interruption, which is detected and used for switching off the generator.

As mentioned above, in another embodiment the optical waveguide 400 is configured to transmit light waves and the transmission of light waves is monitored by way of an evaluation unit 402, such as a lightwave evaluation unit. The transmission of the light waves through the optical waveguide 400 changes when a predetermined temperature is reached or exceeded and this change, in particular an interruption of the transmission, can be detected by the evaluation unit 402.

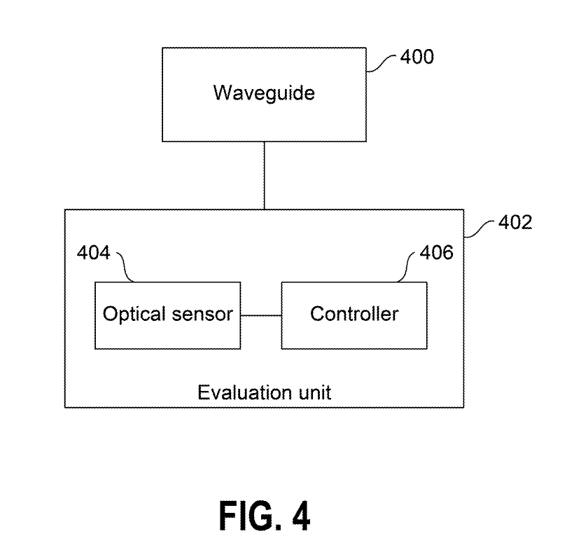

Excessive heating, even only local excessive heating, of the optical waveguide changes the transmission behavior, and this is sensed by the evaluation unit 402. The evaluation unit 402 includes a sensor, such as an optical sensor 404, configured to sense the changes in the transmission behavior. Particularly an interruption can be detected. However, also a change in the quality of the light signal can be detected, in particular a frequency shift or other frequency change. The use of an optical waveguide thus allows the generator to be monitored over its entire circumference by just one optical waveguide. The evaluation unit may also include a controller 406 coupled to the sensor 404 to indicate that the change has occurred (FIG. 4). The evaluation unit 402 may be used with the fuse wire 310 as discussed above and may include at least one of a sensor and a controller.

1. A generator of a gearless wind power installation, comprising:
a rotor and a stator, wherein at least one of the rotor or the stator is provided with a fuse wire for detecting a local temperature increase, and
wherein the fuse wire comprises an electrically conducting material that melts when a predetermined temperature is reached, and thereby interrupts electrical conduction of the fuse wire to detect the local temperature increase.

2. The generator as claimed in claim 1, wherein the fuse wire is located around the stator in an approximately circular manner.

3. The generator as claimed in claim 1, wherein the stator has stator windings that are made up of form-wound coils, wherein the form-wound coils are coupled to one another at coil contact points, and wherein the fuse wire is located along the coil contact points of the stator to detect whether a temperature increase occurs at a coil contact point.

4. The generator as claimed in claim 1, wherein the electrically conducting material of the fuse wire is accommodated in a sheathing in such a way that, in the event the electrically conducting material melts, the electrically conducting material flows in the sheathing in such a way to interrupt the electrical conductivity of the fuse wire.

5. The generator as claimed in claim 4, wherein the sheathing of the fuse wire is configured to withstand a higher temperature than the predetermined temperature.

6. The generator as claimed in claim 1, wherein the predetermined temperature lies in a range of 160° C.-200° C.

7. The generator as claimed in claim 1, wherein the generator is a ring generator.

8. A generator of a gearless wind power installation, comprising:
a rotor and a stator, wherein:
at least one of the rotor or the stator is provided with an optical waveguide for detecting a local temperature increase, and wherein:
the optical waveguide is configured to transmit light waves that are monitored by way of a lightwave evaluation; and
wherein the transmission of the light waves through the optical waveguide changes when a predetermined temperature is reached or exceeded and this change is detected by the lightwave evaluation.

9. A fuse wire for detecting a local temperature increase at a generator of a gearless wind power installation, wherein the fuse wire comprises an electrically conducting material and the electrically conducting material melts when a predetermined temperature is reached and, as a result, brings about an interruption of the electrical line, in order thereby to detect the local temperature increase.

10. The fuse wire as claimed in claim 9, wherein the fuse wire is located around component of a generator.

11. A method comprising:
thermally monitoring coil contact points in a generator of a gearless wind power installation, wherein a fuse wire is led along the coil contacts points, wherein thermally monitoring coil contact points includes measuring conductivity of the fuse wire while the wind power installation is operating, and generating a warning signal in the event the conductivity of the fuse wire deteriorates.

12. The method as claimed in claim 11, wherein when a warning signal is generated, the wind power installation is stopped and the generator is electrically disconnected from electrical terminals.

13. The method as claimed in claim 11, wherein the warning signal is provided to a remote monitoring center.

14. The method as claimed in claim 11, wherein generating the warning signal occurs in the event the conductivity of the fuse wire is interrupted.

15. The generator as claimed in claim 6, wherein the predetermined temperature is a range of 170° C.-190° C.

16. The generator as claimed in claim 6, wherein the predetermined temperature is 180° C.
